(19) United States
(12) Patent Application Publication
(10) Pub. No.: US 2021/0365522 A1
(43) Pub. Date: Nov. 25, 2021

(54) STORAGE MEDIUM, CONVERSION METHOD, AND INFORMATION PROCESSING APPARATUS

(71) Applicant: FUJITSU LIMITED, Kawasaki-shi (JP)

(72) Inventors: Kenichiroh Narita, Kawasaki (JP); Koji MARUHASHI, Hachioji (JP)

(73) Assignee: FUJITSU LIMITED, Kawasaki-shi (JP)

(21) Appl. No.: 17/202,400

(22) Filed: Mar. 16, 2021

(30) Foreign Application Priority Data
May 22, 2020 (JP) 2020-090138

(51) Int. Cl. G06F 17/16; G06N 20/00

(52) U.S. Cl. CPC G06F 17/16; G06N 20/00

(57) ABSTRACT

A conversion method is performed by a computer. The method includes calculating, with respect to a core tensor and a factor matrix generated by decomposing tensor data, a rotational conversion matrix that reduces a value of an element included in the factor matrix, generating, based on the core tensor and an inverse rotational conversion matrix of the rotational conversion matrix, a core tensor after conversion obtained by converting the core tensor, and outputting the core tensor after conversion.

### CROSS-REFERENCE TO RELATED APPLICATION

This application is based upon and claims the benefit of priority of the prior Japanese Patent Application No. 2020-90138, filed on May 22, 2020, the entire contents of which are incorporated herein by reference.

### FIELD

The embodiments discussed herein are related to a storage medium, a conversion method, and an information processing apparatus.

### BACKGROUND

Data, in which relationships among people and things (variable values) such as communication logs, compounds, and the like are recorded, may be expressed as tensor data, and tensor decomposition is used as a method for analyzing such tensor data.

Tensor data are decomposed into a product of a core tensor and a factor matrix, which is approximate to tensor data, by tensor decomposition. The core tensor generated here is data in which the data size (the number of elements) is reduced compared to the tensor data while reflecting the features of the tensor data. The core tensor thus generated may also be used for reinforcement learning in addition to data analysis, and is used for training data of a learning model, input data for determination using the learning model, and the like. Japanese Laid-open Patent Publication No. 2018-055580 is an example of the related art.

### SUMMARY

According to an aspect of the embodiments, a conversion method performed by a computer includes: calculating, with respect to a core tensor and a factor matrix generated by decomposing tensor data, a rotational conversion matrix that reduces a value of an element included in the factor matrix; generating, based on the core tensor and an inverse rotational conversion matrix of the rotational conversion matrix, a core tensor after conversion obtained by converting the core tensor; and outputting the core tensor after conversion.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an information processing apparatus according to Embodiment 1;

FIG. 2 is a diagram illustrating common tensor decomposition;

FIG. 3 is a diagram illustrating a problem of the common tensor decomposition;

FIG. 4 is a diagram illustrating generation of a core tensor according to Embodiment 1;

FIG. 5 is a functional block diagram illustrating a functional configuration of the information processing apparatus according to Embodiment 1;

FIG. 6 is a diagram illustrating a process of concentrating an information amount to a core tensor;

FIG. 7 is a diagram illustrating a new core tensor generation logic;

FIG. 8 is a diagram illustrating calculation of a rotational conversion matrix;

FIG. 9 is a diagram illustrating a new core tensor generation;

FIG. 10 is a diagram illustrating a graph display example by rotational conversion;

FIG. 11 is a flowchart illustrating an example of processing;

FIG. 12 is a diagram illustrating advantages;

FIG. 13 is a diagram illustrating machine learning using a core tensor; and

FIG. 14 is a diagram illustrating an example of a hardware configuration.

### DESCRIPTION OF EMBODIMENTS

There may be a demand for using a core tensor with a reduced number of elements for data explanation or for explanation of learning and determination using data. However, although the core tensor generated by the above-described tensor decomposition is approximated to tensor data by combining the core tensor and the factor matrix, an aspect or a feature of the tensor data may not be inferred from the core tensor alone.

In one aspect, an object is to provide a conversion program, a conversion method, and an information processing apparatus that are capable of visualizing a correspondence relationship between a core tensor and original tensor data.

Hereinafter, embodiments of a conversion program, a conversion method, and an information processing apparatus disclosed herein will be described in detail based on drawings. These embodiments do not limit the present disclosure. The embodiments may be combined with each other as appropriate within the technical scope without contradiction.

### Embodiment 1

[Description of Information Processing Apparatus]

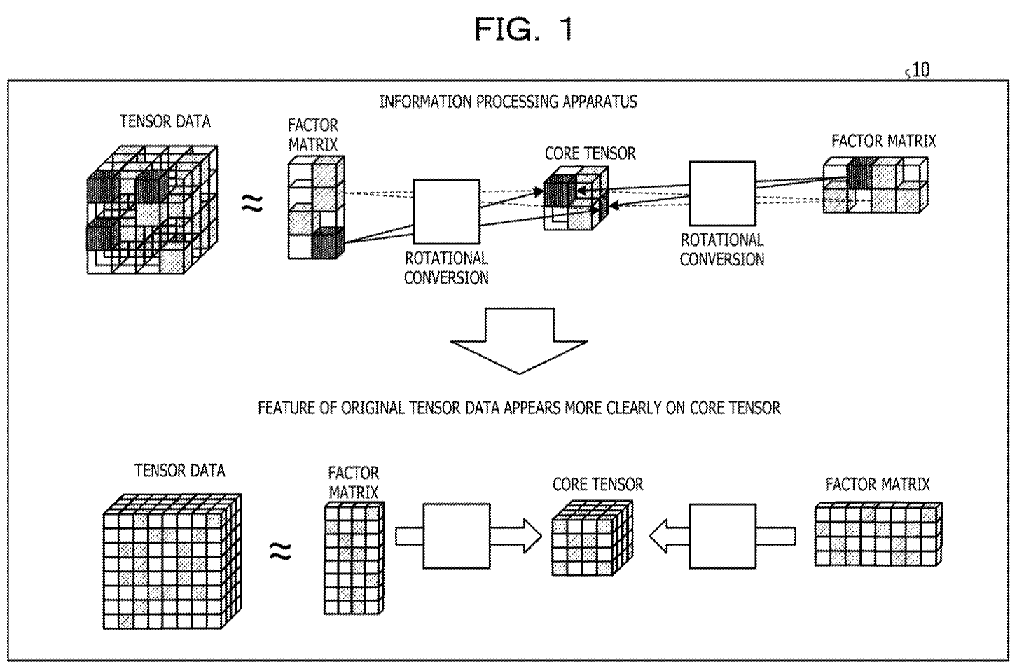

FIG. 1 is a diagram illustrating an information processing apparatus 10 according to Embodiment 1. The information processing apparatus 10 illustrated in FIG. 1 decomposes inputted tensor data into a product of a core tensor and a factor matrix by tensor decomposition. The information processing apparatus 10 executes rotational conversion that minimizes the information amount of the factor matrix obtained by the tensor decomposition, thereby controlling the sizes of elements of the factor matrix and performing control such that the relationship among elements of the core tensor and the original tensor data strongly remains. In this way, the information processing apparatus 10 performs control such that features of the original tensor data more clearly appear on the core tensor.

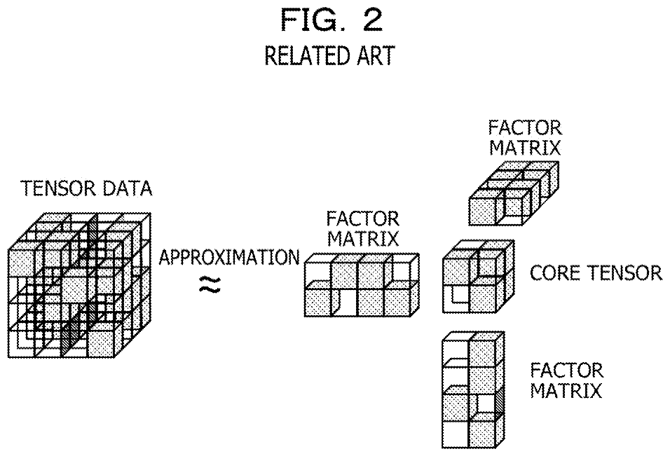

Problems of tensor decomposition executed in the related art will be described. FIG. 2 is a diagram illustrating common tensor decomposition. As illustrated in FIG. 2, inputted tensor data are decomposed into a product of a core tensor and a factor matrix by tensor decomposition. Since the structure of the core tensor reflects a rough structure of the original tensor data, there is a possibility that an abnormal structure or a structure to be noticed may be found. However, since the core tensor usually includes a huge number of elements, it is difficult for a human to recognize all the elements of the core tensor.

For example, even in a core tensor having a size of 10×10×10, the number of elements is 1000, and it is difficult for a human to check all the elements or find features in an overhead view. In a case where a compound having the number of elements of 100, the number of links between elements of 100×100, and the number of types of elements of 100 is represented by the fourth order tensor, there are a maximum of 100,000,000 elements. When the size of a core tensor generated from the fourth order tensor is 50×50×50, the number of elements is 25,000, and it is difficult for a human to find features.

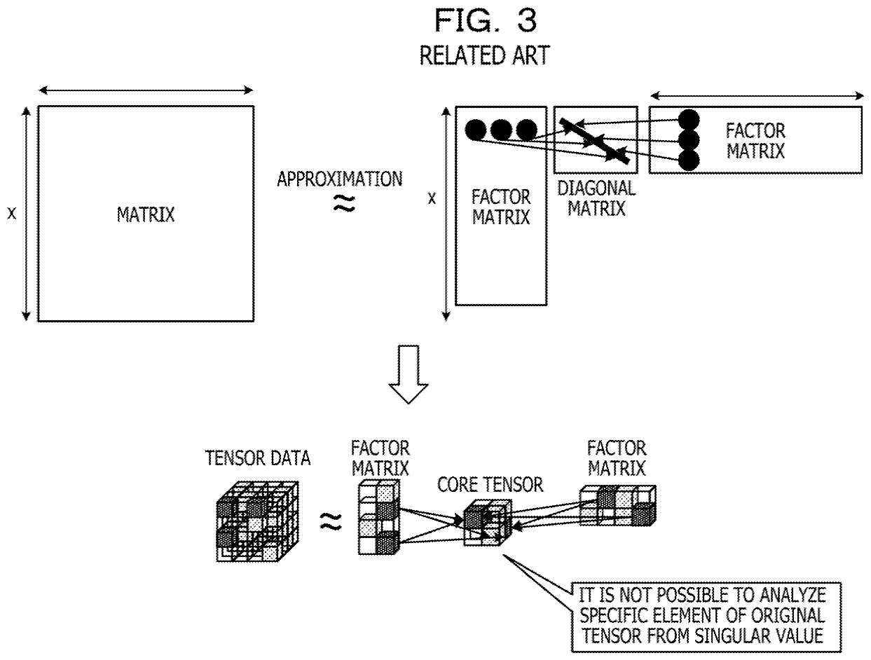

A problem of tensor decomposition is considered with an example in which tensor data are taken as an xy matrix. FIG. 3 is a diagram illustrating a problem of common tensor decomposition. As illustrated in FIG. 3, in the case of a matrix, it is commonly assumed that a factor matrix is an orthogonal matrix and a matrix corresponding to a core tensor is a diagonal matrix (singular value decomposition), and components of the diagonal matrix are called singular values. However, since each element of the original matrix commonly corresponds to a plurality of singular values, it is difficult to associate the structure of the original matrix from the singular values. In the case of tensor decomposition as well, since a calculation method based on singular value decomposition is performed, the same problem occurs.

As described above, for example, when tensor data are represented visually by graphing or the like, the tensor data often result in a complicated graph because of the enormous number of elements. Even if the number of elements is reduced by tensor decomposition, in the core tensor of the related art, a feature may not remain such that a similarity to tensor data is seen in a case of visual representation.

The information processing apparatus 10 according to Embodiment 1 performs rotational conversion on a matrix obtained by decomposition such that elements having large absolute values of a factor matrix is minimized, thereby clarifying the correspondence between elements of the core tensor and the original matrix. For example, the information processing apparatus 10, while reducing the number of elements from that of the original tensor data, even in a case of visual representation, enables generation of a core tensor in which features remain so as to be similar to the original tensor data at a level at which correspondence thereto is obtained to some extent.

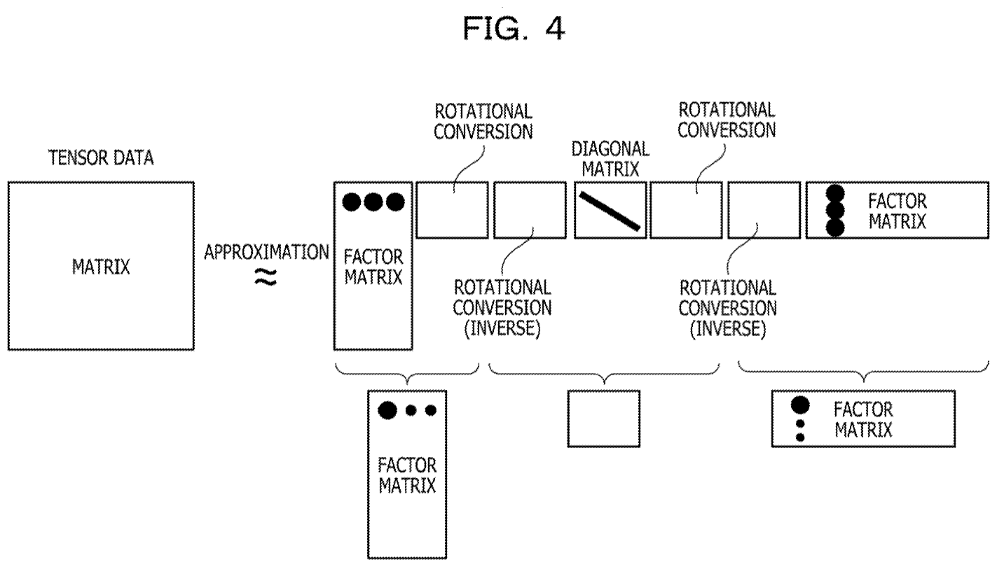

FIG. 4 is a diagram illustrating generation of a core tensor according to Embodiment 1. As illustrated in FIG. 4, with respect to a core tensor and a factor matrix generated by decomposing tensor data, the information processing apparatus 10 (illustrated in FIG. 1) calculates a rotational conversion matrix that reduces values of elements included in the factor matrix. Based on the core tensor and an inverse rotational conversion matrix of the rotational conversion matrix, the information processing apparatus 10 generates a core tensor after conversion obtained by converting the core tensor.

For example, the information processing apparatus 10 calculates the rotational conversion matrix that minimizes an element having a large absolute value among the elements of the factor matrix. The information processing apparatus 10 multiplies the factor matrix and the rotational conversion matrix together to generate a new factor matrix, multiplies the inverse of the rotational conversion matrix (inverse rotational conversion matrix) and the core tensor together to generate a new core tensor, and outputs the core tensor after conversion (new core tensor). In this way, the information processing apparatus 10 is able to integrate an information amount into the core tensor without changing the overall information amount at the time of tensor decomposition, and thus is able to visualize the correspondence relationship between the core tensor and the original tensor data.

[Functional Configuration]

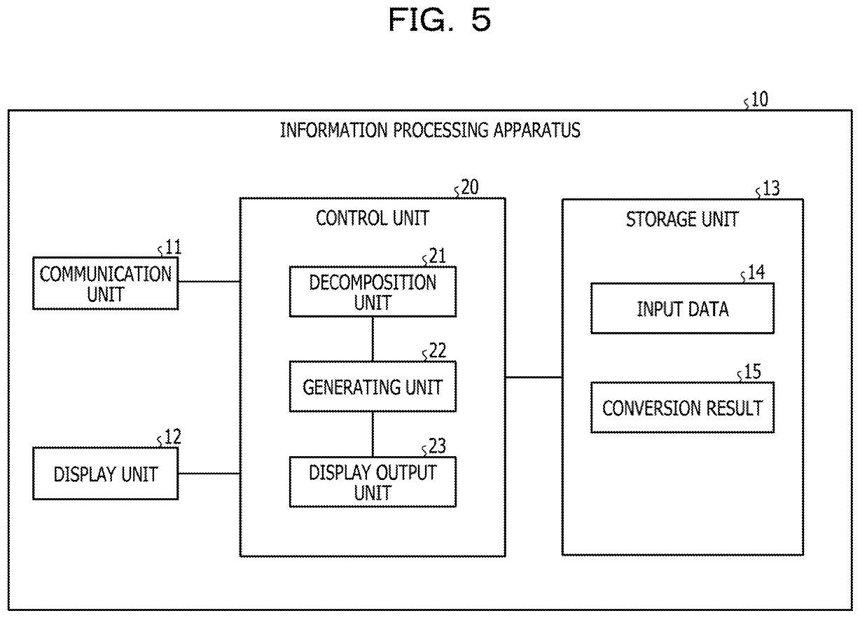

FIG. 5 is a functional block diagram illustrating a functional configuration of the information processing apparatus 10 according to Embodiment 1. As illustrated in FIG. 5, the information processing apparatus 10 includes a communication unit 11, a display unit 12, a storage unit 13, and a control unit 20.

The communication unit 11 is a processing unit that controls communication with other apparatuses and is achieved by, for example, a communication interface. The communication unit 11 receives tensor data from an administrator terminal, a learning machine, or the like (not shown).

The display unit 12 is a processing unit that displays various types of information, and is achieved by, for example, a display, a touch panel, or the like. For example, the display unit 12 displays a core tensor after conversion (new core tensor) generated by the control unit 20, a graph based on the core tensor after conversion, and the like.

The storage unit 13 is an example of a storage device that stores various data, a program to be executed by the control unit 20, and the like and is achieved by, for example, a memory, a hard disk, or the like. This storage unit 13 stores input data 14 and a conversion result 15.

The input data 14 are data to be processed by the control unit 20 and is, for example, tensor data or the like. The input data 14 may be a core tensor obtained after tensor decomposition. The conversion result 15 is a core tensor after conversion that is generated from the input data 14 and has a large amount of information. The conversion result 15 may include a comparison result between the core tensor before conversion and the core tensor after conversion and the like.

The control unit 20 is a processing unit that manages the entire information processing apparatus 10 and is achieved by, for example, a processor or the like. This control unit 20 includes a decomposition unit 21, a generating unit 22, and a display output unit 23. The decomposition unit 21, the generating unit 22, and the display output unit 23 are achieved by an electronic circuit such as a processor or the like, a process executed by the processor, or the like.

The decomposition unit 21 is a processing unit that executes tensor decomposition. For example, the decomposition unit 21 reads the input data 14 that are tensor data from the storage unit 13, and decomposes the input data 14 into a core tensor and a factor matrix by executing tensor decomposition thereon. The decomposition unit 21 outputs to the generating unit 22 or stores in the storage unit 13 the core tensor and the factor matrix obtained by the tensor decomposition.

The generating unit 22 is a processing unit that generates a core tensor after conversion obtained by converting the core tensor generated by the decomposition unit 21 into a core tensor visualized in a form corresponding to the original tensor data. For example, with respect to the core tensor and the factor matrix generated by decomposing the tensor data, the generating unit 22 calculates a rotational conversion matrix that reduces the values of the elements included in the factor matrix. Based on the core tensor and the inverse rotational conversion matrix of the rotational conversion matrix, the generating unit 22 generates and stores in the storage unit 13 a core tensor after conversion obtained by converting the core tensor.

For example, the generating unit 22 generates a new core tensor by concentrating the information amount to the core tensor without changing the entire information amount including the core tensor and the factor matrix obtained by tensor decomposition.

(Information Amount Concentration to Core Tensor)

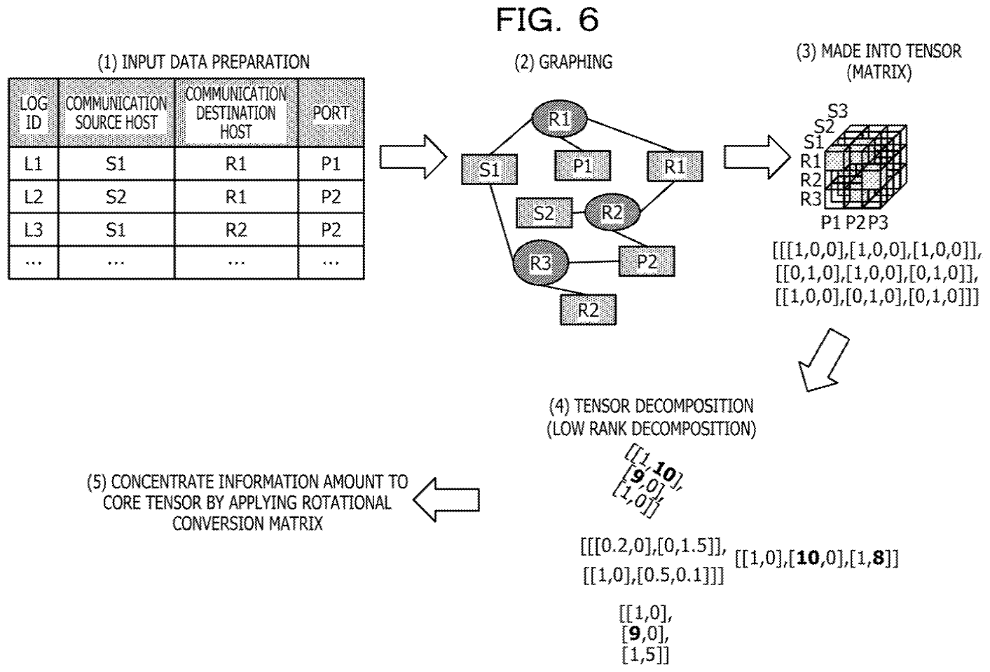

An example of generating a new core tensor will be described with reference to FIG. 6 to FIG. 9. FIG. 6 is a diagram illustrating a process of concentrating an information amount to a core tensor. As illustrated in (1) in FIG. 6, a communication log in which a “log ID” for identifying a log, a “communication source host” indicating a host of a communication source, a “communication destination host” indicating a host of a communication destination, and a “port” indicating a port number used for communication are associated as input data will be described as an example.

First, as illustrated in (2) in FIG. 6, communication logs are graphed. For example, a communication source host “S1”, a communication destination host “R1”, and a port “P1” are each coupled to a log ID “L1”. A log ID “L2” is coupled to the communication destination host “R1”, and a communication source host “S2” and a port “P2” are coupled to the log ID “L2”. A log ID “L3” is coupled to the communication source host “S1”, and a communication destination host “R2” and the port “P2” are coupled to the log ID “L3”.

Next, as illustrated in (3) in FIG. 6, the graphed communication log is made into a tensor (made into a matrix). For example, three-dimensional 3×3×3 tensor data in which R, S, and P are taken as dimensions are generated. For example, in the example of (3) in FIG. 6, in the third order tensor, “R1, P1, S1” corresponds to the log ID “L1” and is colored, and “R1, P2, S2” corresponds to the log ID “L2” and is colored.

As illustrated in (4) in FIG. 6, the decomposition unit 21 performs tensor decomposition on the tensor data obtained by tensorization to decompose the tensor data into a core tensor and a factor matrix. For example, the decomposition unit 21 generates a core tensor composed of four elements of two rows and two columns, two factor matrices composed of three elements of three rows and one column, and a factor matrix composed of three elements of one row and three columns.

Thereafter, as illustrated in (5) in FIG. 6, the generating unit 22 applies the rotational conversion matrix to concentrate the information amount to the core tensor, and generates a new core tensor.

(New Core Tensor Generation Logic)

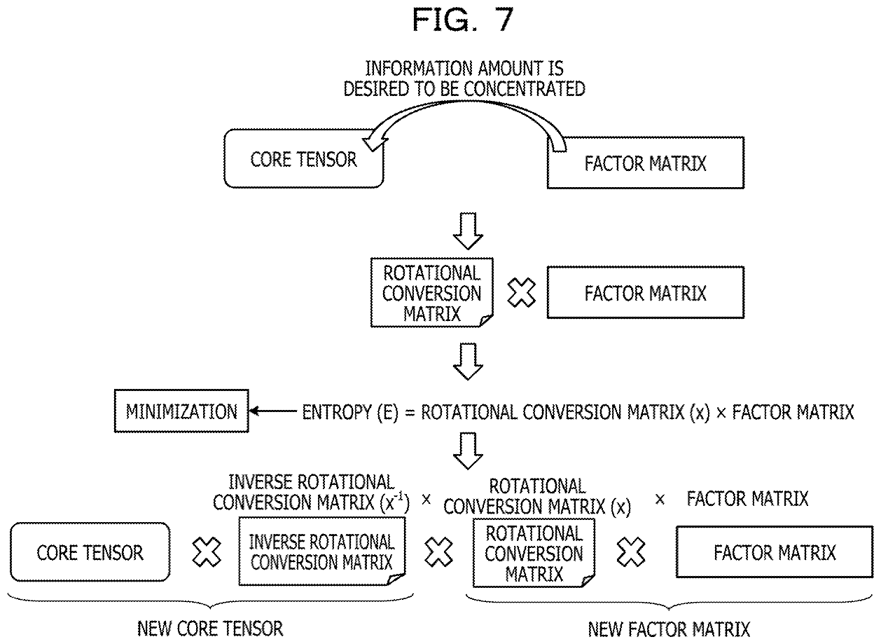

Next, a new core tensor generation process using the rotational conversion matrix will be specifically described. FIG. 7 is a diagram illustrating a new core tensor generation logic. As illustrated in FIG. 7, a core tensor and a factor matrix are generated by tensor decomposition. The core tensor generated here indicates features of the input data. However, since the information amount thereof is not so large, it is difficult for a person to understand a structure or the like indicating the features of the input data only with the core tensor.

Therefore, the information amount of the factor matrix is concentrated to the core tensor. In order to simplify the description, when description is given using one factor matrix, the tensor data may be represented by a product “core tensor×factor matrix” of the “core tensor” and the “factor matrix”. Accordingly, under a restriction that the information amount of the tensor data is not changed, for example, the information amount of the “core tensor×factor matrix” is not changed, the visualization of the core tensor is executed by reducing the information amount of the factor matrix and increasing the information amount of the core tensor.

For example, the factor matrix is multiplied by a rotational conversion matrix (x), by an optimization problem of “entropy (E)=factor matrix×rotational conversion matrix (x)”, the rotational conversion matrix (x) that minimizes the entropy (E) is calculated. In this state, since the information amount is only reduced, in order not to change the information amount, the inverse number (inverse rotational conversion matrix (x⁻¹)) of the rotational conversion matrix (x) is generated, and multiplication by the inverse rotational conversion matrix is further performed. For example, the “core tensor×factor matrix” is converted into “core tensor×inverse rotational conversion matrix (x⁻¹)×rotational conversion matrix (x)×factor matrix”. By taking “core tensor×inverse rotational conversion matrix (x⁻¹)” as a new core tensor and “rotational conversion matrix (x)×factor matrix” as a new factor matrix, it is possible to generate the core tensor (new core tensor) to which the information amount is concentrated without changing the original information amount. This process is executed by using each factor matrix.

(Description of Rotational Conversion Matrix)

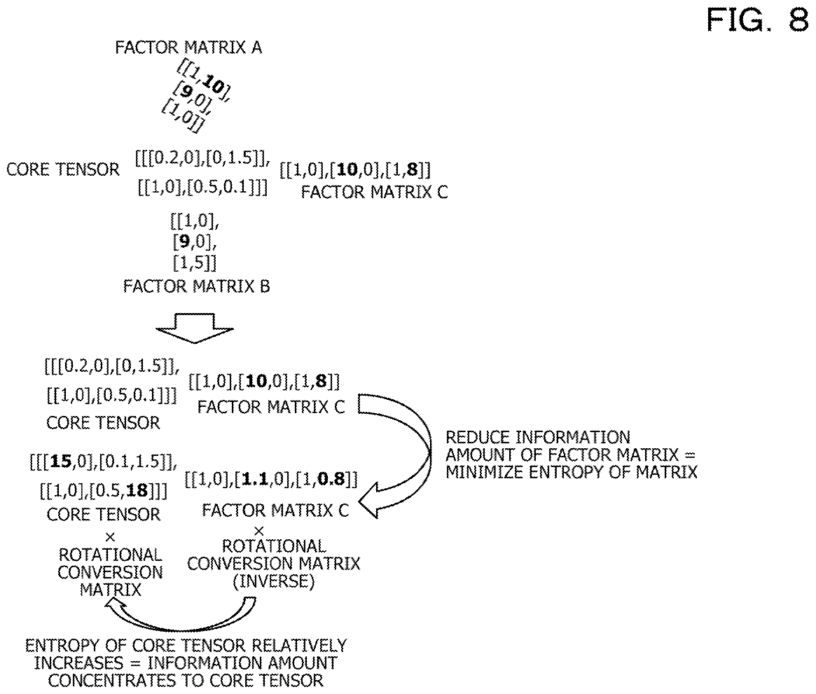

Next, calculation of a rotational conversion matrix will be described. FIG. 8 is a diagram illustrating calculation of a rotational conversion matrix. In FIG. 8, a description will be made using an example of decomposition into a core tensor of two rows and two columns, two factor matrices A and B of three rows and one column, and a factor matrix C of one row and three columns. The core tensor has four elements [[[0.2, 0], [0, 1.5]], [[1, 0], [0.5, 0.1]]]. The factor matrix A has three elements [[1, 10], [9, 0], [1, 0]], the factor matrix B has three elements [[1, 0], [9, 0], [1, 5]], and the factor matrix C has three elements [[1, 0], [10, 0], [1, 8]].

The generating unit 22 calculates a rotational conversion matrix that reduces the information amount of the factor matrix C. For example, the generating unit 22 calculates the rotational conversion matrix by using a gradient method such that the entropy of the factor matrix is minimized. In order to make the information amounts coincide with each other without affecting tensor decomposition, the generating unit 22 calculates an inverse rotational conversion matrix of the rotational conversion matrix and multiplies the core tensor by the inverse rotational conversion matrix, thereby generating a new core tensor obtained by converting the core tensor.

For example, when the description is made by using the factor matrix C as an example, the three elements [[1, 0], [10, 0], [1, 8]] are converted into [[1, 0], [1.1, 0], [1, 0.8]] to reduce the information amount, and by concentrating the reduced information amount to the core tensor, the four elements [[[0.2, 0], [0, 1.5]], [[1, 0], [0.5, 0.1]]] of the core tensor are converted into [[[15, 0], [0.1, 1.5]], [[1, 0], [0.5, 18]]]. As a result, the entropy of the core tensor relatively increases, and the information amount concentrates to the core tensor (new core tensor). The process described with reference to FIG. 8 is executed for each factor matrix.

(Generation of New Core Tensor)

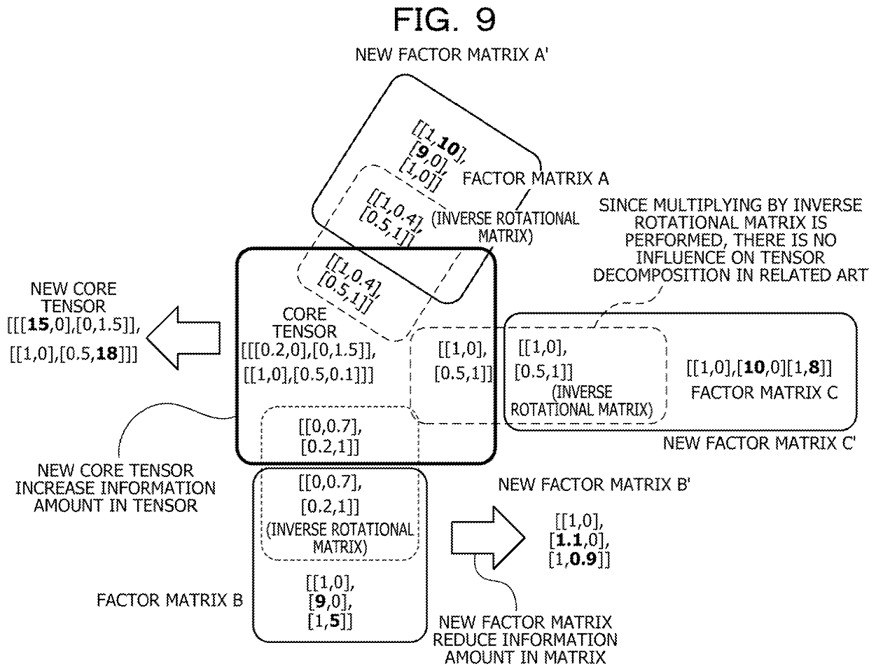

Generation of a new core tensor by conversion of the core tensor described above will be described. FIG. 9 is a diagram illustrating a new core tensor generation. As illustrated in FIG. 9, the generating unit 22 generates a rotational conversion matrix [[1, 0.4], [0.5, 1]] for the factor matrix A, and calculates an inverse rotational conversion matrix of this rotational conversion matrix. In the same manner, the generating unit 22 generates a rotational conversion matrix [[0, 0.7], [0.2, 1]] for the factor matrix B, and calculates an inverse rotational conversion matrix of this rotational conversion matrix. The generating unit 22 generates a rotational conversion matrix [[1, 0], [0.5, 1]] for the factor matrix C, and calculates an inverse rotational conversion matrix of this rotational conversion matrix.

As a result, the generating unit 22 multiplies the core tensor [[[0.2, 0], [0, 1.5]], [[1, 0], [0.5, 0.1]]] by each of the inverse rotational conversion matrices calculated by using each of the factor matrices to generate a new core tensor [[[15, 0], [0, 1.5]], [[1, 0], [0.5, 18]]]. The generating unit 22 multiplies the factor matrix A [[1, 10], [9, 0], [1, 0]] by the rotational conversion matrix [[1, 0.4], [0.5, 1]] to generate a new factor matrix A′. In the same manner, the generating unit 22 multiplies the factor matrix B [[1, 0], [9, 0], [1, 5]] by the rotational conversion matrix [[0, 0.7], [0.2, 1]] to generate a new factor matrix B′ [[1, 0], [1.1, 0], [1, 0.9]], and multiplies the factor matrix C [[1, 0], [10, 0], [1, 8]] by the rotational conversion matrix [[1, 0], [0.5, 1]] to generate a new factor matrix C.

In this way, the generating unit 22 may generate, while maintaining the overall information amount at the time of tensor decomposition, the new core tensor in which the information amount is integrated, and the new factor matrix A′, the new factor matrix B′, and the new factor matrix C′ in each of which the information amount is reduced. The generating unit 22 stores the various types of information generated here in the storage unit 13 as the conversion result 15.

Returning to FIG. 5, the display output unit 23 is a processing unit that reads the conversion result 15 from the storage unit 13 and outputs the conversion result to the display unit 12. For example, the display output unit 23 outputs a new core tensor generated based on the core tensor after tensor decomposition to the display unit 12. The display output unit 23 may generate graph data from the new core tensor and output the graph data. For the conversion into the graph data, a known technique using scale information of the original graph data and the like, a visualization tool, a drawing tool, or the like may be used.

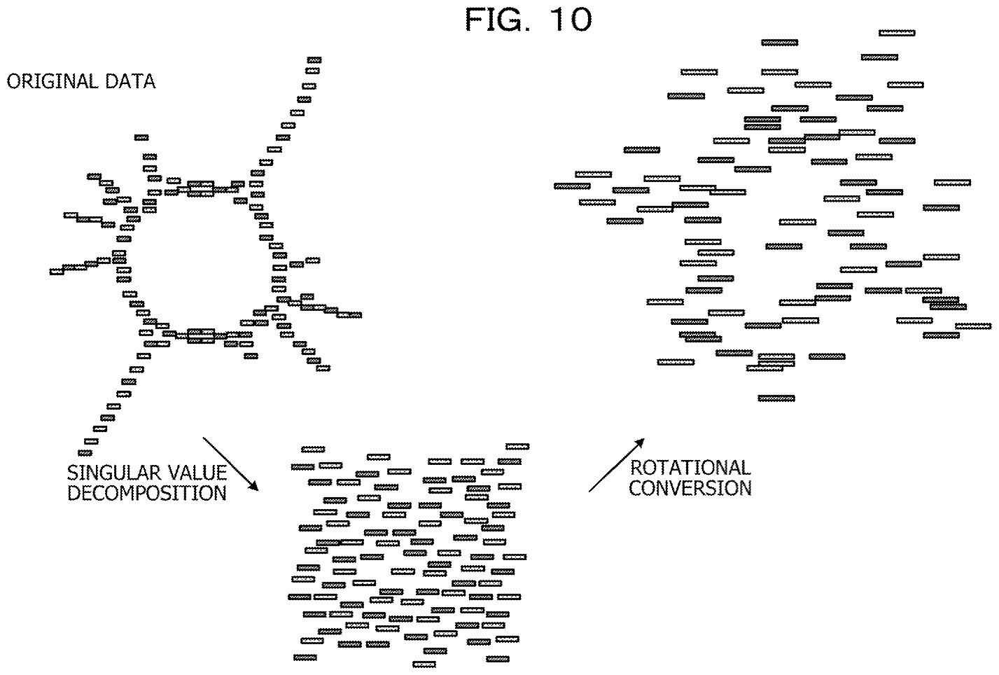

FIG. 10 is a diagram illustrating a graph display example by rotational conversion. As illustrated in FIG. 10, when a core tensor (diagonal matrix) generated by singular value decomposition based on the original data is graphed, a rough feature is expressed, but a person may not easily understand the feature. By graphing and displaying the new core tensor converted by the rotational conversion using the core tensor, the display output unit 23 may present to the user a graph in which the feature amount of the original data is relatively easy to be understood.

[Example of Processing]

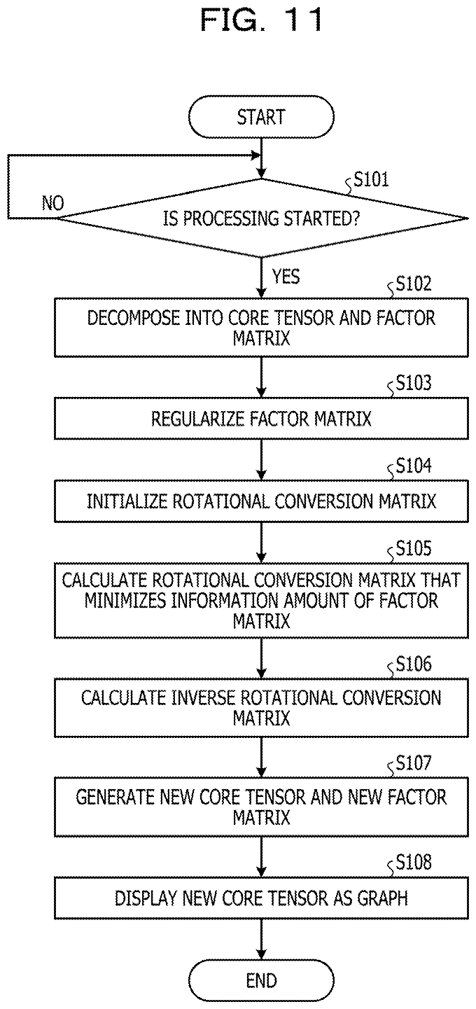

FIG. 11 is a flowchart illustrating an example of processing. As illustrated in FIG. 11, when an instruction to start a process is given by an administrator or the like (S101: Yes), the decomposition unit 21 executes tensor decomposition on tensor data, which are input data, to decompose the tensor data into a core tensor and a factor matrix (S102).

Subsequently, the generating unit 22 regularizes the factor matrix (S103), initializes a rotational conversion matrix (S104), and calculates a rotational conversion matrix that minimizes the information amount of the factor matrix (S105).

For example, the generating unit 22 calculates, from a multiplication result (V^{T}×W) of V^{T} calculated from a matrix V obtained by regularizing the factor matrix and a rotational conversion matrix W, a correction amount of W, and updates W based on the correction amount. Subsequently, the generating unit 22 performs singular value decomposition on the rotational conversion matrix W to generate a diagonal matrix (S) corresponding to a core tensor and orthogonal matrices (P and Q) corresponding to factor matrices. The generating unit 22 calculates entropy E from the matrices V and W by assuming W=P×Q, and calculates W with which the entropy is minimized by a stochastic gradient descent method. At this time, when the decrease in entropy is equal to or smaller than a certain value, the optimization is ended. The algorithm described here is merely an example, and it is possible to adopt algorithms for various optimization problems that minimize the entropy of the rotational conversion matrix and the factor matrix, and it is also possible to adopt optimization methods other than the stochastic gradient descent method.

After that, the generating unit 22 calculates an inverse rotational conversion matrix of the rotational conversion matrix (S106). The generating unit 22 generates a new core tensor and a new factor matrix by using the core tensor, the factor matrix, the rotational conversion matrix, and the inverse rotational conversion matrix (S107). After that, the display output unit 23 displays the new core tensor as a graph (S108).

[Effects]

As described above, by minimizing the information amount of the correspondence relationship among the elements of the original data and the core tensor, the information processing apparatus 10 may visualize the correspondence relationship between the core tensor and the original tensor data. The new core tensor+new factor matrix generated in Embodiment 1 is different from the common core tensor+factor matrix described in FIG. 2 and the like, but is obtained by changing in expression the common core tensor+factor matrix by the rotational conversion, and is therefore still approximate to the original tensor data. For example, the information processing apparatus 10 may generate the new core tensor in which the information amount is integrated while suppressing harmful effects of the conversion.

Since the relationship between the elements of the core tensor and the elements of the original data is clarified, the information processing apparatus 10 makes it possible to recognize the entire structure with reference to the original data, and makes it easy to find an abnormality or a structure to be noticed.

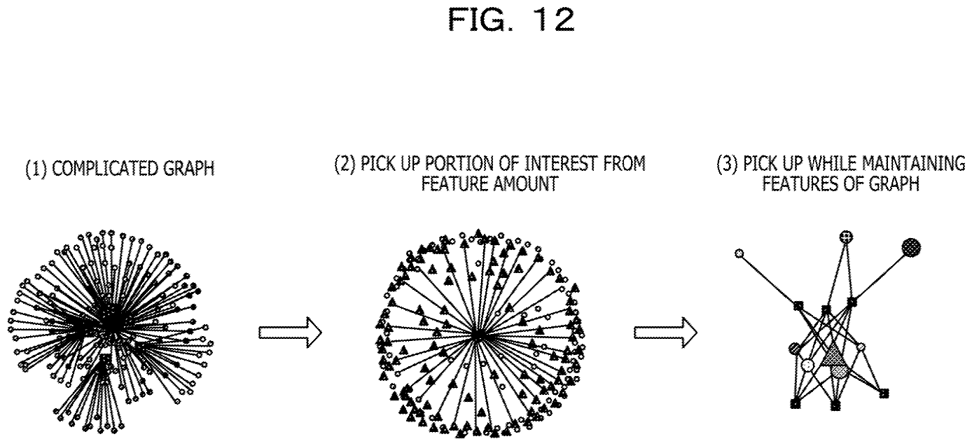

FIG. 12 is a diagram illustrating advantages. In FIG. 12, the usefulness of specifying the entire structure using the new core tensor in which the information amount is integrated will be described. In FIG. 12, description is given by using a transaction history of an enterprise as input data. An example in which a transaction history of an enterprise is graphed is illustrated in (1) in FIG. 12, in which circular nodes indicate enterprises, square marks indicate timings when the transactions are performed, and lines indicate actually performed transactions. As illustrated in (1) in FIG. 12, graphing a large number of pieces of transaction history data results in a complicated graph, it is not possible for a human to perform analysis, and it is not possible to specify an important viewpoint, a feature, or the like.

Next, a graph based on a core tensor at the time of tensor decomposition for tensor data generated from the graph of the transaction history data is illustrated in (2) in FIG. 12. As illustrated in (2) in FIG. 12, even if it is attempted to specify a portion of interest from a feature amount, since the information amount is still large, it is not possible for a human to perform analysis in an overhead view.

Finally, a graph based on a new core tensor that is generated from the core tensor at the time of tensor decomposition and into which the information amount is integrated is illustrated in (3) in FIG. 12. As illustrated in (3) in FIG. 12, it is possible to display a graph in which the information amount is reduced compared to that in (1) in FIG. 12 while maintaining the feature of the graph. For this reason, it is also easy for a human to check a portion of interest and to perform analysis. Thus, if it is possible to extract a deformed graph from the original graph, a feature element may be detected therefrom. For example, it becomes easy to analyze that triangular marks among a large number of pieces of transaction history information are important.

### Embodiment 2

While the embodiment of the present disclosure has been described, the present disclosure may be implemented in various different forms other than the above-described embodiment.

[Numerical Values or the Like]

The numerical values, the matrices, the tensor data, the number of dimensions, the optimization method, the optimization algorithm, the specific example, the application target, and the like used in the above-described embodiments are merely examples, and may be arbitrarily changed. Tensor decomposition may also be executed by another apparatus, and a new core tensor may also be generated by acquiring a core tensor generated by another apparatus.

[Application Example]

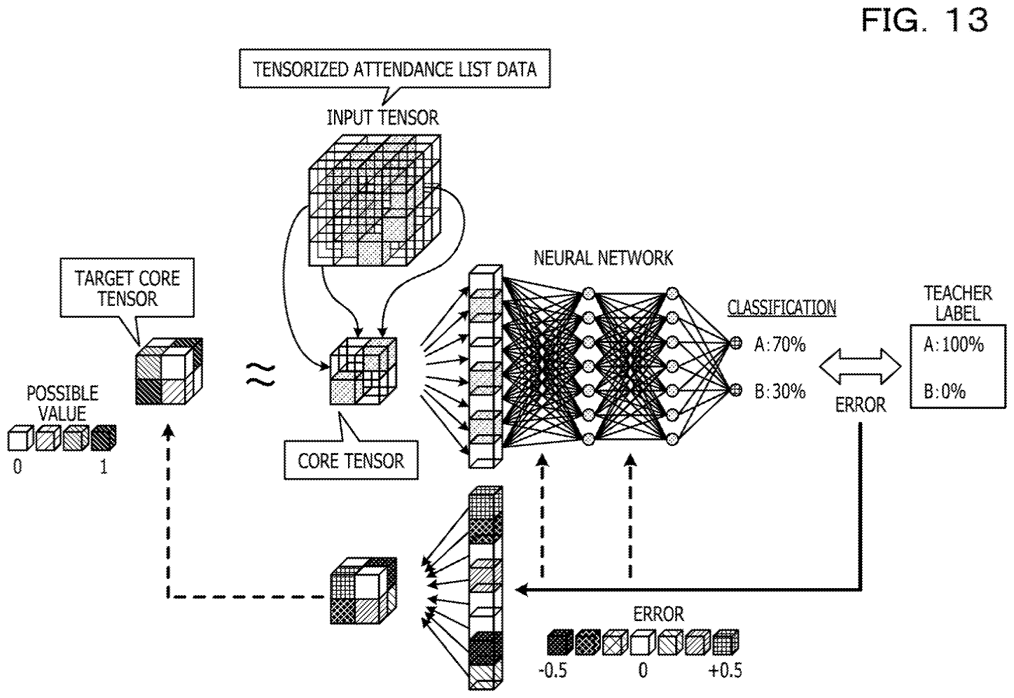

The above-described conversion from the core tensor to the new core tensor may be applied to machine learning using the core tensor. FIG. 13 is a diagram illustrating machine learning using a core tensor. As illustrated in FIG. 13, for example, the learning apparatus generates an input tensor from learning data that are attendance list data to which a teacher label (labels A and B) of attendance rate data to a workplace is attached, performs tensor decomposition on the input tensor, and generates a core tensor so as to be similar to a target core tensor initially randomly generated. The learning apparatus inputs the core tensor to a neural network (NN) to acquire a classification result (label A: 70%, label B: 30%). Thereafter, the learning apparatus calculates a classification error between the classification result (label A: 70%, label B: 30%) and the teacher label (label A: 100%, label B: 0%), and executes learning of the prediction model and learning of the tensor decomposition method by using the expanded error propagation method obtained by expanding the error back-propagation method.

For example, the learning apparatus corrects various parameters of NN so as to reduce a classification error in such a manner that the classification error is propagated to a lower layer with respect to an input layer, an intermediate layer, and an output layer which are included in NN. The learning apparatus propagates the classification error to the target core tensor, and modifies the target core tensor so as to approach a feature pattern indicating features of a partial structure of the graph contributing to prediction.

In such machine learning, the information processing apparatus 10 may acquire a core tensor from the learning apparatus and execute the process described in Embodiment 1 to generate a new core tensor. For example, every time the learning apparatus performs tensor decomposition in the learning process, the information processing apparatus 10 acquires a core tensor and factor matrices from the learning apparatus, generates and transmits a new core tensor and new factor matrices to the learning apparatus. As a result, the learning apparatus may execute machine learning by using the new core tensor in which the features of the original graph data are represented.

The information processing apparatus 10 may acquire the core tensor and the factor matrices from the learning apparatus at an arbitrary timing in the learning process of the learning apparatus, generate the new core tensor and the new factor matrices, and display the new core tensor or graph data based on the new core tensor. As a result, the information processing apparatus 10 may present an index such as a learning status, learning progress, and the like to the user. The user may recognize the learning status, the learning progress, and the like by analyzing the features using the new core tensor or the graph data based on the new core tensor. Therefore, it is possible to efficiently perform machine learning by quickly detecting a status in which the learning progress is delayed or a status in which expected accuracy is not obtained, and executing collection of teacher data, annotation, and the like. The learning apparatus and the information processing apparatus 10 may be implemented by the same apparatus. The same may apply to determination using the learned model.

[System]

Unless otherwise specified, processing procedures, control procedures, specific names, and information including various types of data and parameters described in the above description or illustrated in the drawings may be arbitrarily changed. The generating unit 22 is an example of a calculation unit and a generating unit, and the display output unit 23 is an example of an output unit.

The elements of each illustrated apparatus are of functional concepts, and the apparatus is not necessarily physically configured as illustrated in the drawings. For example, the specific form of distribution or integration of each apparatus is not limited to those illustrated in the drawings. For example, the entirety or part of the apparatus may be configured so as to be functionally or physically distributed or integrated in an arbitrary unit in accordance with various types of load, usage states, or the like.

All or an arbitrary subset of the processing functions performed by each apparatus may be realized by a central processing unit (CPU) and programs to be analyzed and executed by the CPU or may be realized by a hardware apparatus using wired logic.

[Hardware]

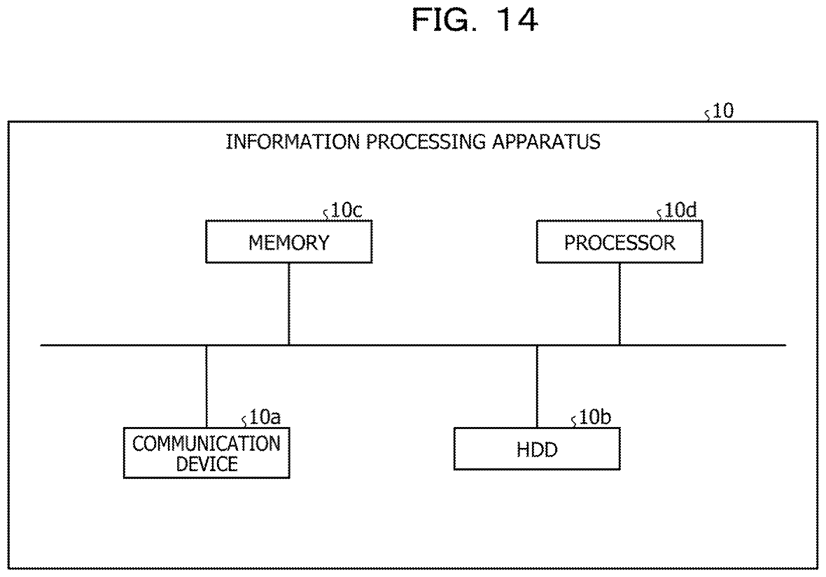

Next, a hardware configuration will be described. FIG. 14 is a diagram illustrating an example of a hardware configuration. As illustrated in FIG. 14, the information processing apparatus 10 includes a communication device 10a, a hard disk drive (HDD) 10b, a memory 10c, and a processor 10d. The components illustrated in FIG. 14 are coupled to one another by a bus or the like.

The communication device 10a is a network interface card or the like and communicates with another server. The HDD 10b stores programs that causes the functions illustrated in FIG. 5 to operate and a database (DB).

The processor 10d reads from the HDD 10b or the like the programs that perform processing similar to the processing performed by the processing units illustrated in FIG. 5 and loads the read programs on the memory 10c, thereby a process that performs the functions illustrated in, for example, FIG. 5 is operated. For example, this process performs the functions similar to the functions of the processing units included in the information processing apparatus 10. For example, the processor 10d reads, from the HDD 10b or the like, the program having the same functions as the decomposition unit 21, the generating unit 22, the display output unit 23, and the like. The processor 10d executes the processes that perform the same processing as that of the decomposition unit 21, the generating unit 22, the display output unit 23, and the like.

As described above, the information processing apparatus 10 is operated as an information processing apparatus that performs the various information processing methods by reading and executing the programs. The information processing apparatus 10 may also realize the similar functions to those of the above-described embodiment by reading programs from a recording medium with a medium reading device and executing the read programs. The programs described for another embodiment are not limited to the programs to be executed by the information processing apparatus 10. For example, the present disclosure may be similarly applied to the case where another computer or server executes the programs or the case where the other computer and server cooperate with each other to execute the programs.

All examples and conditional language provided herein are intended for the pedagogical purposes of aiding the reader in understanding the invention and the concepts contributed by thee inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium having stored therein a conversion program for causing a computer to execute a process comprising:
calculating, with respect to a core tensor and a factor matrix generated by decomposing tensor data, a rotational conversion matrix that reduces a value of an element included in the factor matrix;
generating, based on the core tensor and an inverse rotational conversion matrix of the rotational conversion matrix, a core tensor after conversion obtained by converting the core tensor; and
outputting the core tensor after conversion.

2. The storage medium according to claim 1,
wherein the calculating includes calculating, by solving an optimization problem of entropy between a result of executing singular value decomposition on the rotational conversion matrix and the factor matrix, the rotational conversion matrix that minimizes the entropy.

3. The storage medium according to claim 1,
wherein the outputting includes generating, based on graph data that are a generation source of the tensor data, graph data from the core tensor after conversion and outputting the graph data.

4. The storage medium according to claim 1, the process further comprising:
generating the tensor data from learning data; and
generating a model by executing machine learning by using, as an input, a core tensor generated by decomposing the tensor data,
wherein the calculating includes acquiring the core tensor in a generation process of the model by the machine learning and calculating the rotational conversion matrix, and
the outputting includes outputting the core tensor after conversion as an index that indicates a learning status of the machine learning.

5. A conversion method performed by a computer, the method comprising:
calculating, with respect to a core tensor and a factor matrix generated by decomposing tensor data, a rotational conversion matrix that reduces a value of an element included in the factor matrix;
generating, based on the core tensor and an inverse rotational conversion matrix of the rotational conversion matrix, a core tensor after conversion obtained by converting the core tensor; and
outputting the core tensor after conversion.

6. An information processing apparatus comprising:
a memory, and
a processor coupled to the memory and configured to:
calculate, with respect to a core tensor and a factor matrix generated by decomposing tensor data, a rotational conversion matrix that reduces a value of an element included in the factor matrix;
generate, based on the core tensor and an inverse rotational conversion matrix of the rotational conversion matrix, a core tensor after conversion obtained by converting the core tensor; and
output the core tensor after conversion.
